(19) United States
(12) Patent Application Publication
(10) Pub. No.: US 2011/0298990 A1
(43) Pub. Date: Dec. 8, 2011

(54) DIGITAL BROADCAST RECEIVING APPARATUS AND DIGITAL BROADCAST RECEIVING METHOD

(75) Inventors: Yasuhiro ISHII, Kyoto (JP); Shuichi TAKAYAMA, Hyogo (JP); Ryoko MIYACHI, Hyogo (JP)

(73) Assignee: PANASONIC CORPORATION, Osaka (JP)

(21) Appl. No.: 13/214,649

(22) Filed: Aug. 22, 2011

Related U.S. Application Data
(63) Continuation of application No. PCT/JP2010/000761, filed on Feb. 9, 2010.

(30) Foreign Application Priority Data
Mar. 2, 2009 (JP) 2009-048551

(51) Int. Cl. H04N 5/50

(52) U.S. Cl. 348/731; 348/E05.097

(57) ABSTRACT

A digital broadcast receiving apparatus includes a channel selection control unit selecting a channel of a digital broadcast, a demultiplexing unit and a video decoder obtaining video data and data broadcast data from electrical wave of the digital broadcast of the channel selected by the channel selection control unit, a data broadcast accumulation unit accumulating the data broadcast data obtained by the acquisition unit for each channel, and a rendering unit and a video composition unit generating composite video data by reading out the data broadcast data of at least one channel that includes a channel different from a channel of the video data obtained by the acquisition unit from the data broadcast accumulation unit and combining the readout data broadcast data and the video data obtained by the acquisition unit.

### CROSS REFERENCE TO RELATED APPLICATION

This is a continuation application of PCT application No. PCT/JP2010/000761 filed on Feb. 9, 2010, designating the United States of America.

### BACKGROUND OF THE INVENTION

(1) Field of the Invention

The present invention relates to a digital broadcast receiving apparatus and a digital broadcast receiving method, and in particular, to video-sound watching and listening and a usage of data broadcast.

(2) Description of the Related Art

Digital broadcast distributes data broadcast content together with video-sound content which is content including videos and sounds. In a digital broadcast receiving apparatus, data in which the data broadcast content is rendered by browser software, and so on, for decompressing the data broadcast content and the video-sound content can be used at the same time.

The data broadcast content is distributed on each broadcast channel independently. However, the data broadcast content which has little relationship with the video-sound content in the broadcast channel is often distributed. Thus, a viewer often would like use data broadcast content which is distributed on a channel different from that of video-sound content which the viewer currently watches and listens to.

There is a known technique in which, even when a switch from the data broadcast content to the next data broadcast content occurs during watching and listening to video-sound content, a viewer can keep watching and listening to data broadcast content which the viewer has been watching and listening to instead of next data broadcast content (refer to Japanese Unexamined Patent Application Publication No. 2007-201766, hereinafter referred to as Patent Reference 1).

Moreover, there are also known data broadcast receiving apparatus and tuner control apparatus described in Japanese Unexamined Patent Application Publication No. 2000-308026 (hereinafter referred to as Patent Reference 2) as a technique relating to an accumulation of data broadcast.

### SUMMARY OF THE INVENTION

However, the conventional digital broadcast receiving apparatus is designed so that video-sound content which a viewer watches and listens to and data broadcast content which is distributed on the same channel as the video-sound content at the same time can be used together in the same screen. Accordingly, when switching the broadcast channel of the video-sound content during use of the data broadcast content, the displaying of the data broadcast content which has been used is interrupted, and only the data broadcast content distributed on the newly selected channel can be used. Even in the data broadcast receiving apparatuses described in the Patent References 1 and 2, when the channel of the video-sound content is switched, the channel of the data broadcast content is also switched. Thus, there is a problem that the channel of the video-sound content and the channel of the data broadcast content can not be switched independently from each other.

The present invention is to solve the above problem, and an object of the present invention is to provide a digital broadcast receiving apparatus which can change a data broadcast content channel, which is a channel whose data broadcast content is used, without changing a video-sound content channel, which is a channel whose video-sound content is watched and listened to, or change the video-sound content channel without changing the data broadcast content channel.

To solve the above problem, the digital broadcast receiving apparatus according to an aspect of the present invention that receives electrical wave of a digital broadcast and outputs video data of the digital broadcast, the digital broadcast receiving apparatus includes: a channel selection control unit which selects a channel of the digital broadcast; an acquisition unit which obtains video data and data broadcast data from electrical wave of the digital broadcast of the channel selected by the channel selection control unit; a data broadcast accumulation unit which has a storage region for each channel and accumulates the data broadcast data obtained by the acquisition unit in the storage region of the channel selected by the channel selection control unit; and a composition unit which generates composite video data by reading out the data broadcast data of at least one channel that includes a channel different from a channel of the video data obtained by the acquisition unit from the data broadcast accumulation unit and combining the readout data broadcast data and the video data obtained by the acquisition unit.

In particular, the acquisition unit includes: a front-end unit which demodulates the electrical wave of the digital broadcast of the channel selected by the channel selection control unit into digital signals; a demultiplexing unit which demultiplexes encoded video data and data broadcast data from the digital signals; and a video decoder which decodes the encoded video data, and the data broadcast accumulation unit has a storage region for each channel and accumulates the data broadcast data demultiplexed by the demultiplexing unit in the storage region of the channel selected by the channel selection control unit, and the composition unit includes: a rendering unit which generates picture data of data broadcast data of at least one channel which includes a channel different from the channel of the electrical wave of the digital broadcast demodulated by the front-end unit in accordance with the data broadcast data accumulated in the data broadcast accumulation unit; and a video composition unit which generates composite video data by combining the video data decoded by the video decoder and the picture data generated by the rendering unit.

With this configuration, the data broadcast data is stored in the data broadcast accumulation unit for each channel. Thus, the data broadcast data of the desired channel can be read out from the data broadcast accumulation unit. Consequently, a user can use the pre-accumulated data broadcast data which is different from the video which the user currently watches.

It is preferable that the digital broadcast receiving apparatus further includes: a CM (Commercial Message) detection unit which detects a CM of the digital broadcast of the channel specified by the channel selection control unit; and a system control unit which controls the channel selection control unit to select a channel which is different from a channel corresponding to the electrical wave which is currently demodulated by the front-end unit during a period of time when the CM detection unit detects a CM.

The newest data broadcast data of the channel which is different from the channel which the user currently watches is accumulated in the data broadcast accumulation unit by controlling the channel selection control unit to select the channel which the user currently watches during the CM period.

It is more preferable that the CM detection unit detects a CM in accordance with a change of supplementary information included in the encoded video data.

It is more preferable that the CM detection unit detects a CM in accordance with a state that a timing of a switch between a CM and a program (or vice versa) indicates a moment at which the supplementary information included in the encoded video data changes.

It is more preferable that demultiplexing unit demultiplexes encoded video data, encoded sound data, and data broadcast data from the digital signals, the digital broadcast receiving apparatus further includes a sound decoder which decodes the encoded sound data, and the CM detection unit detects a CM in accordance with a change of supplementary information included in the encoded sound data.

It is more preferable that the demultiplexing unit demultiplex encoded video data, encoded sound data, and data broadcast data from the digital signals, the digital broadcast receiving apparatus further includes a sound decoder which decodes the encoded sound data, and the CM detection unit detects a CM in accordance with a state that a timing of a switch between a CM and a program (or vice versa) indicates a moment at which the supplementary information included in the encoded video data changes.

According to any of these configurations, the timing of the CM start can be detected by focusing on the changing point of the video and sound.

It is more preferable that the digital broadcast receiving apparatus further includes: a state management unit which manages a period of time when the front-end unit or the demultiplexing unit can be operated for purpose of accumulating the data broadcast data in the data broadcast accumulation unit; and a system control unit which controls the selection channel control unit to select at least one channel in a period of time when the front-end unit or the demultiplexing unit can be operated for purpose of accumulating the data broadcast data in the data broadcast accumulation unit.

It is more preferable that the state management unit manages a period of time when electrical power of the digital broadcast receiving apparatus is turned on as a period of time when the front-end unit or the demultiplexing unit can be operated except for a purpose of accumulating the data broadcast data in the data broadcast accumulation unit, and the state management unit manages a period of time when electrical power of the digital broadcast receiving apparatus is turned off as a period of time when the front-end unit or the demultiplexing unit can be operated for purpose of accumulating the data broadcast data in the data broadcast accumulation unit.

According to this configuration, the digital broadcast receiving apparatus of the present invention can detect the period of time when the channel of the data broadcast data can be selected except for the purpose that the user watches and listens to the video-sound data.

The digital broadcast receiving apparatus according to another aspect of the present invention that receives electrical wave of a digital broadcast and outputs video data of the digital broadcast, the digital broadcast receiving apparatus includes: a first channel selection control unit which selects a first channel of the digital broadcast; a second channel selection control unit which selects a second channel of the digital broadcast; a first front-end unit which demodulates the electrical wave of the digital broadcast of the channel selected by the first channel selection control unit into first digital signals; a second front-end unit demodulates the electrical wave of the digital broadcast of the channel selected by the second channel selection control unit into second digital signals; a first demultiplexing unit which demultiplexes encoded video data and data broadcast data from the first digital signals; a second demultiplexing unit which demultiplexes encoded video data and data broadcast data from the second digital signals; a video decoder which decodes the encoded video data demultiplexed by the first demultiplexing unit; a data broadcast accumulation unit which has a storage region for each channel and accumulates the data broadcast data demultiplexed by the second demultiplexing unit in the storage region of the channel selected by the second channel selection control unit; a rendering unit which generates picture data of data broadcast data of at least one channel which includes a channel different from the channel of the electrical wave of the digital broadcast demodulated by the first front-end unit in accordance with the data broadcast data accumulated in the data broadcast accumulation unit; and a video composition unit which generates synthesized video data by combining the video data decoded by the video decoder and the picture data generated by the rendering unit.

According to this configuration, the data broadcast data is stored in the data broadcast accumulation unit for each channel. Thus, the data broadcast data of the desired channel can be read out from the data broadcast accumulation unit. Consequently, the data broadcast data which is different from the video which the user currently watches can be sent out to the rendering unit.

The digital broadcast receiving apparatus according to yet another aspect of the present invention that receives electrical wave of a digital broadcast and outputs video data of the digital broadcast, the digital broadcast receiving apparatus includes: a first channel selection control unit which selects a first channel of the digital broadcast; a second channel selection control unit which selects a second channel of the digital broadcast; a first front-end unit which demodulates the electrical wave of the digital broadcast of the channel selected by the first channel selection control unit into first digital signals; a second front-end unit which demodulates the electrical wave of the digital broadcast of the channel selected by the second channel selection control unit into second digital signals; a first demultiplexing unit which demultiplexes encoded video data and data broadcast data from the first digital signals; a second demultiplexing unit which demultiplexes encoded video data and data broadcast data from the second digital signals; a video decoder which decodes the encoded video data demultiplexed by the first demultiplexing unit or the second demultiplexing unit; a data broadcast accumulation unit which has a storage region for each channel, accumulates the data broadcast data demultiplexed by the first demultiplexing unit in the storage region of the channel selected by the first channel selection control unit, and accumulates the data broadcast data demultiplexed by the second demultiplexing unit in the storage region of the channel selected by the second channel selection control unit; a rendering unit which generates picture data of data broadcast data of at least one channel which includes a channel different from the channel of the electrical wave of the digital broadcast demodulated by the first front-end unit or the second front-end unit in accordance with the data broadcast data accumulated in the data broadcast accumulation unit; and a video composition unit which generates composite video data by combining the video data decoded by the video decoder and the picture data generated by the rendering unit.

According to this configuration, the data broadcast data is stored in the data broadcast accumulation unit for each channel. Thus, the data broadcast data of the desired channel can be read out from the data broadcast accumulation unit. Consequently, the data broadcast data which is different from the video which the user currently watches can be sent out to the rendering unit.

The present invention can be achieved not only as the digital broadcast receiving apparatus provided with the above characteristic processing units but also as the digital broadcast receiving method having the steps of the characteristic processing units included in the digital broadcast receiving apparatus. Moreover, the present invention can also be achieved as a program which causes a computer to execute the characteristic steps included in the digital broadcast receiving method. The above program can be distributed via a recording medium such as CD-ROM (Compact Disc-Read Only Memory) etc. and a communication network such as Internet etc.

The present invention makes it possible to change the data broadcast content channel without changing a video-sound content channel or change the video-sound content channel without changing the data broadcast content channel.

### FURTHER INFORMATION ABOUT TECHNICAL BACKGROUND TO THIS APPLICATION

The disclosure of Japanese Patent Application No. 2009-048551 filed on Mar. 2, 2009 including specification, drawings and claims is incorporated herein by reference in its entirety.

The disclosure of PCT application No. PCT/JP2010/000761 filed on Feb. 9, 2010, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram illustrating a functional configuration of a digital broadcast receiving apparatus according to Embodiment 1 of the present invention;

FIG. 2 is a flow chart relating to a taking of a data broadcast when receiving a digital broadcast according to Embodiment 1 of the present invention;

FIG. 3 is a flow chart showing an accumulation process of the data broadcast data in detail according to Embodiments 1 and 2 of the present invention;

FIG. 4 is a flow chart of a process for using the data broadcast when receiving the digital broadcast according to Embodiment 1 of the present invention;

FIG. 5 is a diagram illustrating an example of a television screen according to Embodiments 1 and 2 of the present invention;

FIG. 6 is a diagram illustrating an example of a television screen according to Embodiments 1 and 2 of the present invention;

FIG. 7 is a diagram illustrating an example of a television screen according to Embodiments 1 and 2 of the present invention;

FIG. 8 is a block diagram illustrating a functional configuration of a digital broadcast receiving apparatus according to Embodiment 2 of the present invention;

FIG. 9 is a flow chart relating to a taking of a data broadcast when receiving a digital broadcast according to Embodiment 2 of the present invention;

FIG. 10 is a flow chart of a process for using the data broadcast when receiving the digital broadcast according to Embodiment 2 of the present invention; and

FIG. 11 is a diagram illustrating an example of a television screen according to Modification of the present invention.

### DESCRIPTION OF THE PREFERRED EMBODIMENTS

Embodiments of the present invention are described with reference to the drawings. Basic configuration, operation, etc. of a digital broadcast receiving apparatus are well known by a skilled person. Thus, a detailed description of them is not repeated here.

### Embodiment 1

In Embodiment 1, a digital broadcast receiving apparatus which can receive a digital broadcast of one channel at the same time is described.

The digital broadcast is made up of videos and sounds and a data broadcast which are independent for each channel. The data broadcast is transmitted in carousel form.

Content of the data broadcast is a hypertext form described in markup language such as BML (Broadcast Markup Language), for example.

The data broadcast content is designed to be used with videos and sounds which are distributed on the same channel as the data broadcast content.

At first, a functional configuration of the digital broadcast receiving apparatus according to Embodiment 1 is described.

For example, the digital broadcast receiving apparatus according to Embodiment 1 is a household television or a household set-top box. The digital broadcast receiving apparatus according to Embodiment 1 may be applied to a portable television, a personal computer having a digital broadcast receiving function, a personal digital assistant (PDA), and a household video recording equipment.

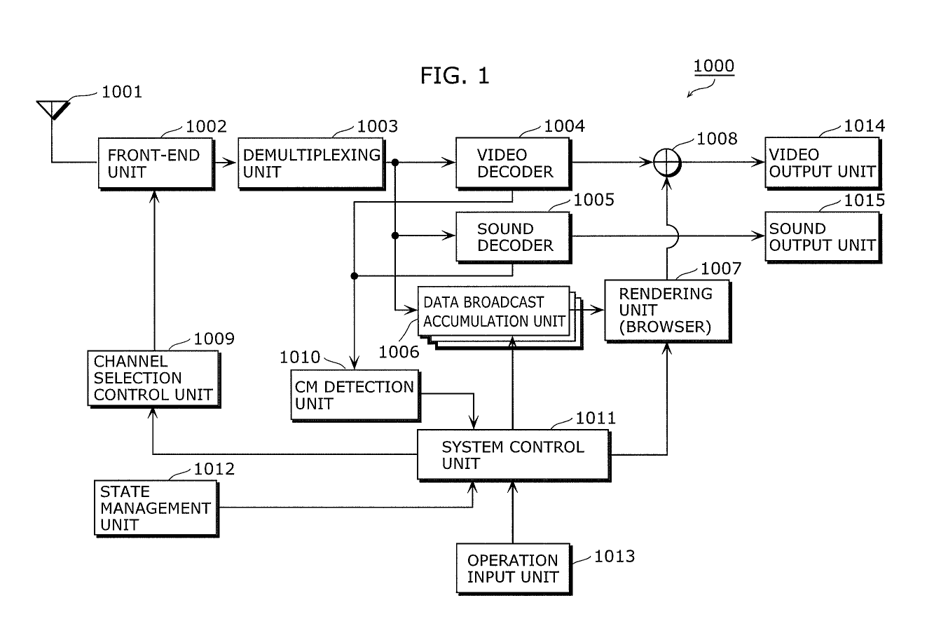

FIG. 1 is a block diagram illustrating a functional configuration of the digital broadcast receiving apparatus according to Embodiment 1.

A digital broadcast receiving apparatus 1000 illustrated in FIG. 1 receives a terrestrial digital broadcast or a BS (broadcasting satellite) digital broadcast. The digital broadcast receiving apparatus 1000 includes an antenna 1001, a front-end unit 1002, a demultiplexing unit 1003, a video decoder 1004, a sound decoder 1005, a data broadcast accumulation unit 1006, a rendering unit (browser) 1007, a video composition unit 1008, a channel selection control unit 1009, a CM detection unit 1010, a system control unit 1011, a state management unit 1012, an operation input unit 1013, a video output unit 1014, and a sound output unit 1015.

The antenna 1001 is a receiving antenna which receives electrical wave of the terrestrial digital broadcast, the BS digital broadcast, etc.

The front-end unit 1002 extracts and demodulates electrical wave in a specific frequency range from the electrical wave received by the antenna 1001 and converts the electrical wave into a transport stream which is composed of transport stream packets in which plural data are multiplexed. That is to say, the front-end unit 1002 selects a predetermined channel of a broadcast wave and extracts a transport stream in electrical wave of the predetermined channel.

The demultiplexing unit 1003 demultiplexes the data included in the transport stream which is outputted from the front-end unit 1002. In particular, the demultiplexing unit 1003 demultiplexes encoded video data included in the respective transport stream packets, encoded sound data, and data broadcast data.

The video decoder 1004, which conforms to MPEG (Moving Picture Experts Group) 2, H.264, etc., decodes the encoded video data demultiplexed by the demultiplexing unit 1003 and generates the video data after the decode.

The sound decoder 1005, which conforms to MPEG2-AAC (Advanced Audio Coding) etc., decodes the encoded sound data demultiplexed by the demultiplexing unit 1003 and generates the sound data after the decode.

The data broadcast accumulation unit 1006 accumulates the data broadcast data in the transport stream packet which is transmitted in carousel form. Moreover, the data broadcast accumulation unit 1006 has a region to accumulate the data broadcast data individually for each channel of the broadcast waves, and sends out the individual data broadcast data to the rendering unit 1007 by a command from the system control unit 1011 described below.

The rendering unit 1007 interprets the data broadcast data sent out from the data broadcast accumulation unit 1006 in accordance with a notation in the data broadcast data and generates picture data for displaying the data broadcast data. For example, the rendering unit 1007 interprets the data broadcast data of hypertext form described in BML or the like and generates the picture data of the data broadcast data.

The video composition unit 1008 combines the video data generated by the video decoder 1004 and the picture data of the data broadcast data generated by the rendering unit 1007 or selects one of these data, and outputs the combined data or the selected data to the video output unit 1014.

The channel selection control unit 1009 selects the channel of the digital broadcast. That is to say, upon receiving the command to select the channel from the system control unit 1011, the channel selection control unit 1009 sends a command to select the channel to the front-end unit 1002. The front-end unit 1002 can thereby extract and demodulate the electrical wave of the commanded channel and convert it into the transport stream.

When CM detection unit 1010 detects the switching of the video or sound, for example, in the video data and video supplementary information included in the video data generated by the video decoder 1004 or the sound data and sound supplementary information included in the sound data generated by the sound decoder 1005, the CM detection unit 1010 generates a timing information which indicates timings of a CM start and a CM end. The CM detection unit 1010 sends the timing information to the system control unit 1011. For example, the CM detection unit 1010 may detect the timings of the CM start and the CM end by detecting a switching between a bilingual broadcast and a stereo broadcast, a switching between a monaural broadcast and a stereo broadcast, or the like in the sound supplementary information. Moreover, the CM detection unit 1010 may detect the timings of the CM start and the CM end by monitoring a change of a video aspect information included in the video supplementary information.

The state management unit 1012 manages a period of time when the system control unit 1011 can control the front-end unit 1002 and the demultiplexing unit 1003 (a period of time when the system control unit 1011 can control the front-end unit 1002 and the demultiplexing unit 1003 for purpose of accumulating the data broadcast data in the data broadcast accumulation unit 1006) except for a purpose that a user watches and listens to the videos and sounds of television (except for a purpose of outputting the data to the video output unit 1014 and the sound output unit 1015) and sends the period of time to the system control unit 1011. In that period of time, in the front-end unit 1002 and the demultiplexing unit 1003, the channel can be selected for purpose other than watching and listening to the videos and sounds. For example, even during a period of time when electrical power is turned off by a user operation, the state management unit 1012 manages the state that the front-end unit 1002 and the demultiplexing unit 1003 can be controlled and sends it to the system control unit 1011, as long as the digital broadcast receiving apparatus 1000 is made up of the respective processing units which can operate in background. The purpose of the user watching and listening to the videos and sounds may include a purpose of the user recording the videos and sounds of television.

The operation input unit 1013 sends information of operation switches (not illustrated) pressed to operate the digital broadcast receiving apparatus 1000 to the system control unit 1011. The digital broadcast receiving apparatus 1000 may be operated by receiving an operation command from infrared light outputted from an infrared remote controller or receiving an operation command from electrical signals transmitted from other control circuit other than operating the operation switches.

The system control unit 1011 controls the channel selection control unit 1009 to select a channel different from that which corresponds to the electrical wave demodulated by the front-end unit 1002 currently during a period of time when the CM detection unit 1010 detects a CM. That is to say, the system control unit 1011 controls a channel selection for watching a television in accordance with the operation command from the operation input unit 1013. Moreover, the system control unit 1011 determines the period of time when the system control unit 1011 can control the front-end unit 1002 and the demultiplexing unit 1003 in accordance with the information from the state management unit 1012 and the CM detection unit 1010 and controls the channel selection control unit 1009 for purpose of accumulating the data broadcast data in the data broadcast accumulation unit 1006. Moreover, the system control unit 1011 controls a start-up and end of the rendering unit 1007 when watching the television and sends a command to send out the data broadcast data used in the rendering unit 1007 to the data broadcast accumulation unit 1006.

The video output unit 1014 outputs a video to a display panel or the like. The video output unit 1014 is connected to the display panel or the like via an external output terminal such as a component terminal and a HDMI (High-Definition Multimedia Interface) terminal, or a dedicated interface with the display panel.

The sound output unit 1015 outputs sounds to a speaker or the like. The sound output unit 1015 outputs the sound from an analog sound output terminal, an optical digital terminal, a coaxial terminal, or a HDMI terminal and outputs the sound directly to a built-in speaker device via a built-in amplifier circuit or the like.

According to the above configuration, the digital broadcast receiving apparatus 1000 receives the data broadcast of each channel at the time which is detected by the CM detection unit 1010 and the state management unit 1012 and accumulates the data broadcast in the data broadcast accumulation unit 1006, so that the digital broadcast data which was broadcast on the other channel can be used while watching a certain digital broadcast channel.

Subsequently, an operation of the digital broadcast receiving apparatus 1000 is described.

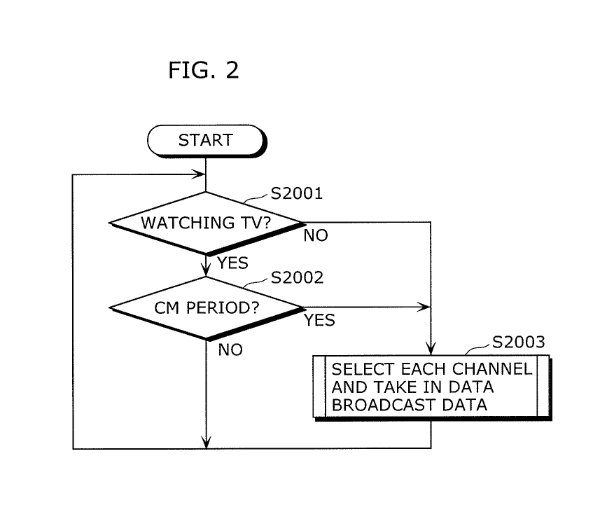

FIG. 2 is a flow chart showing a processing flow of accumulating the data broadcast data in the data broadcast accumulation unit 1006.

Here, there are three digital broadcast channels which can be received, that is, channels A, B, and C.

The system control unit 1011 determines whether or not the user watches the television in accordance with the information from the state management unit 1012 and the information held in the system control unit 1011 (S2001).

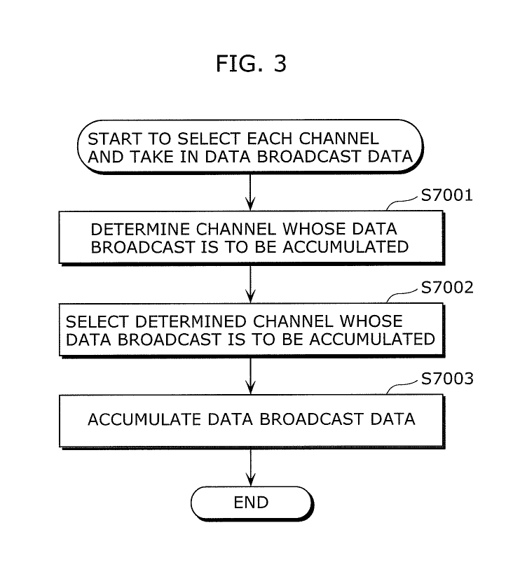

When determining that the user does not watch the television (NO in S2001), the digital broadcast receiving apparatus 1000 performs an accumulation process of the data broadcast data of each channel (S2003). Details of the data broadcast data accumulation process (S2003) are described below with reference to a flow chart in FIG. 3.

When determining that the user watches the television (YES in S2001), the system control unit 1011 determines whether or not the CM detection unit 1010 detects a CM period (S2002).

When determining that the CM detection unit 1010 detects the CM period (YES in S2002), the digital broadcast receiving apparatus 1000 performs the data broadcast data accumulation process (S2003).

When determining that the user watches the television and the CM detection unit 1010 does not detect the CM period (YES in S2001 and NO in S2002), the process of S2001 and S2002 is repeatedly performed.

FIG. 3 is a flow chart showing the details of the data broadcast data accumulation process (S2003 in FIG. 2).

The system control unit 1011 selects a channel to accumulate the data broadcast data (S7001). Here, the system control unit 1011 selects preferentially the channel whose data broadcast data is not yet accumulated in the data broadcast accumulation unit 1006 and then selects a channel whose data broadcast data is the oldest in the accumulated data broadcast data. Here, the channel A is selected.

Subsequently, the system control unit 1011 sends a command to select the channel A to the channel selection control unit 1009 and sends a command to start accumulating the data broadcast data of the channel A to the data broadcast accumulation unit 1006. Upon receiving the channel selection command from the channel selection control unit 1009, the front-end unit 1002 receives and demodulates the electrical wave from the antenna 1001 and then outputs the multiplexed transport stream to the demultiplexing unit 1003 (S7002).

The demultiplexing unit 1003 analyzes the multiplexed transport stream outputted from the front-end unit 1002 and sends out the transport stream packet including the data broadcast data to the data broadcast accumulation unit 1006. The data broadcast accumulation unit 1006 accumulates the data broadcast data which corresponds to the channel A (S7003).

When the user watches the television or during the CM period (NO in S2001 or YES in S2002 in FIG. 2), the data broadcast data accumulation process (S2003) is repeatedly performed. Thus, after the data broadcast data of the channel A is accumulated, the system control unit 1011 selects subsequently the channel B and the channel C, which can be watched and also distribute the data broadcast, switches the channels repeatedly, and accumulates the data broadcast data.

The CM period is generally several tens of seconds, so that when the system control unit 1011 determines that the data broadcast has already been taken for a certain period of time, the system control unit 1011 finishes accumulating the data broadcast data, switches the channel to watch the television broadcast which the user has been watching so that the user can continue watching the television.

Subsequently, a process of using the data broadcast data accumulated in the data broadcast accumulation unit 1006 during watching the television is described.

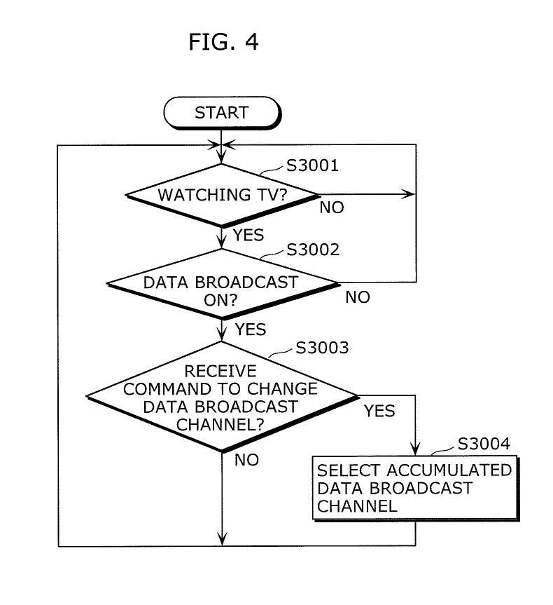

FIG. 4 is a flow chart showing a process flow when using the data broadcast data accumulated in the data broadcast accumulation unit 1006 during watching the television.

Firstly, the system control unit 1011 determines whether or not the user watches the television in accordance with the information from the state management unit 1012 and the information held in the system control unit 1011 (S3001).

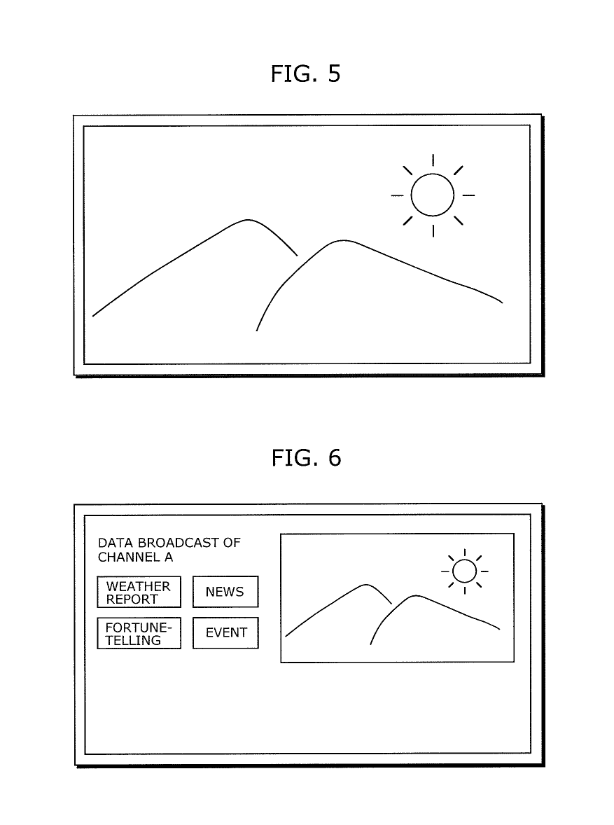

When determining that the user watches the television (YES in S3001), the system control unit 1011 determines whether or not to display the data broadcast in accordance with the command from the operation input unit 1013 or the state in the system control unit 1011 (S3002). When displaying the data broadcast (YES in S3002), the system control unit 1011 sends a command to output the data broadcast data of the channel which the user watches to the data broadcast accumulation unit 1006. For example, when the user instructs to display the data broadcast using the operation input unit 1013 while watching a program of channel A as shown in FIG. 5, the program of channel A (the video data) and the data broadcast data of channel A are displayed on the television screen as shown in FIG. 6.

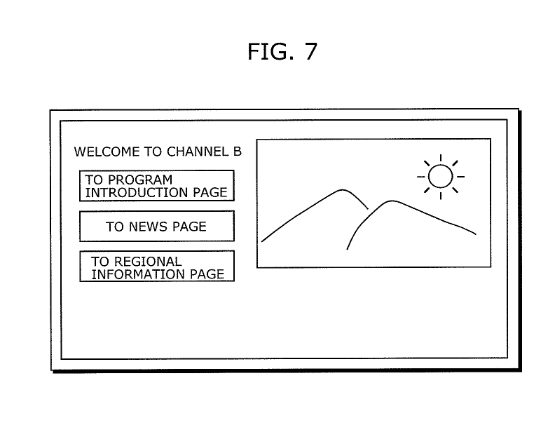

Subsequently, when the system control unit 1011 receives a command to change the data broadcast channel from the operation input unit 1013 (YES in S3003), the system control unit 1011 sends a command to change an output channel of the data broadcast data to the data broadcast accumulation unit 1006. The data broadcast accumulation unit 1006 transmits the valid data broadcast data which is already accumulated in the data broadcast accumulation unit 1006 or the data broadcast data which is being accumulated in the data broadcast accumulation unit 1006 to the rendering unit 1007 (S3004). Thereby, the data broadcast is updated. For example, when a command is sent to change the output data of the data broadcast data to the channel B with a television screen displayed as shown in FIG. 6, the program of channel A (the video data) and the data broadcast data of channel B are displayed on the television screen as shown in FIG. 7.

Although Embodiment 1 describes the example of fixing the channel of the program which the user watches and changing the channel of the data broadcast data, it is also applicable to change the channel of the program which the user watches and fix the channel of the data broadcast data.

As described above, according to Embodiment 1, the data broadcast accumulation unit 1006 accumulates the data broadcast data of all channels in advance. Thus, it is possible to change a data broadcast content channel, which is a channel whose data broadcast content is used, without changing a video-sound content channel, which is a channel whose video-sound content is watched and listened to, or change the video-sound content channel without changing the data broadcast content channel.

### Embodiment 2

Subsequently, Embodiment 2 is described below. A digital broadcast receiving apparatus according to Embodiment 2 includes two front-end units, two demultiplexing units, and two channel selection control units.

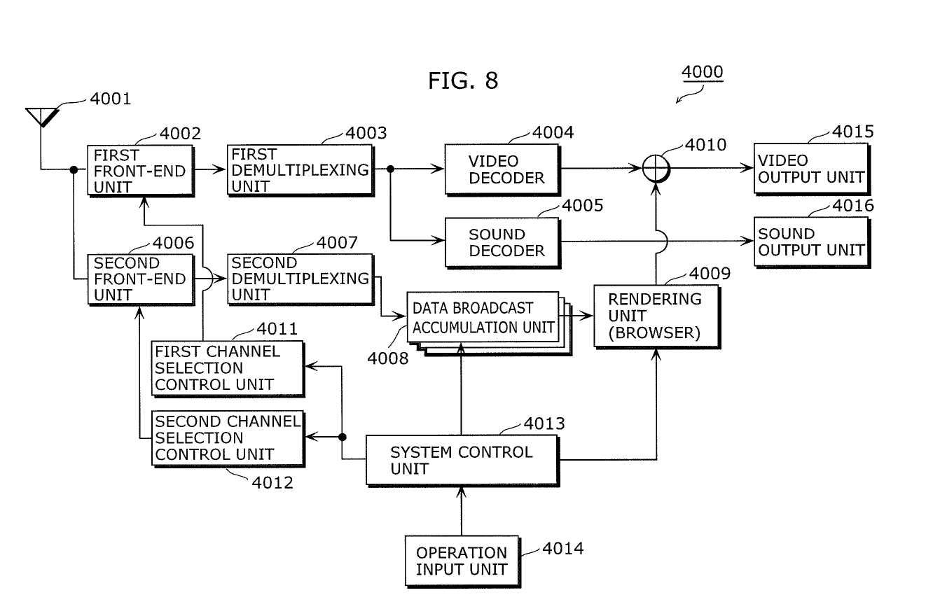

FIG. 8 is a block diagram illustrating a functional configuration of the digital broadcast receiving apparatus according to Embodiment 2.

A digital broadcast receiving apparatus 4000 shown in FIG. 8 receives a terrestrial digital broadcast or a BS digital broadcast. The digital broadcast receiving apparatus 4000 includes an antenna 4001, a first front-end unit 4002, a first demultiplexing unit 4003, a video decoder 4004, a sound decoder 4005, a second front-end unit 4006, a second demultiplexing unit 4007, a data broadcast accumulation unit 4008, a rendering unit 4009, a video composition unit 4010, a first channel selection control unit 4011, a second channel selection control unit 4012, a system control unit 4013, an operation input unit 4014, a video output unit 4015, and a sound output unit 4016.

The antenna 4001 is a receiving antenna which receives electrical wave of the terrestrial digital broadcast, the BS digital broadcast, etc.

The first front-end unit 4002 extracts and demodulates electrical wave in a specific frequency range from the electrical wave received by the antenna 4001 and converts the electrical wave into a transport stream which is composed of transport stream packets in which plural data are multiplexed. That is to say, the first front-end unit 4002 selects a predetermined channel of a broadcast wave and extracts a transport stream in electrical wave of the predetermined channel.

The first demultiplexing unit 4003 demultiplexes the data included in the transport stream which is outputted from the first front-end unit 4002. In particular, the first demultiplexing unit 4003 demultiplexes encoded video data included in the respective transport stream packets, encoded sound data, and data broadcast data. In Embodiment 2, the first demultiplexing unit 4003 outputs the transport stream packets composed of the video data and the sound data which are watched and listened to.

The video decoder 4004, which conforms to MPEG2, H.264, etc., decodes the encoded video data demultiplexed by the first demultiplexing unit 4003 and generates the decoded video data.

The sound decoder 4005, which conforms to MPEG2-AAC etc., decodes the encoded sound data demultiplexed by the first demultiplexing unit 4003 and generates the decoded sound data.

The second front-end unit 4006 extracts and demodulates electrical wave in a specific frequency range from the electrical wave received by the antenna 4001 and converts the electrical wave into a transport stream which is composed of transport stream packets in which plural data are multiplexed. That is to say, the second front-end unit 4006 selects a predetermined channel of a broadcast wave and extracts a transport stream in electrical wave of the predetermined channel.

The second demultiplexing unit 4007 demultiplexes the data included in the transport stream which is outputted from the second front-end unit 4006. In particular, the second demultiplexing unit 4007 demultiplexes encoded video data included in the respective transport stream packets, encoded sound data, and data broadcast data. In Embodiment 2, the second demultiplexing unit 4007 outputs the transport stream packets which are composed of the data broadcast data for using the data broadcast.

The data broadcast accumulation unit 4008 accumulates the data broadcast data in the transport stream packet which is transmitted in carousel form. Moreover, the data broadcast accumulation unit 4008 has a region to accumulate the data broadcast data individually for each channel of the broadcast waves, and sends out the individual data broadcast data to the rendering unit 4009 by a command from the system control unit 4013 described below.

The rendering unit 4009 interprets the data broadcast data sent out from the data broadcast accumulation unit 4008 in accordance with a notation in the data broadcast data and generates picture data for displaying the data broadcast data. For example, the rendering unit 4009 interprets the data broadcast data of hypertext form described in BML or the like and generates the picture data of the data broadcast data.

The video composition unit 4010 combines the video data generated by the video decoder 4004 and the picture data of the data broadcast data generated by the rendering unit 4009 or selects one of these data, and outputs the combined data or the selected data to the video output unit 4015.

The first channel selection control unit 4011 selects the channel of the digital broadcast. That is to say, upon receiving the command to select the channel from the system control unit 4013, the first channel selection control unit 4011 sends a command to select the channel to the first front-end unit 4002. The first front-end unit 4002 can thereby extract and demodulate the electrical wave of the commanded channel and convert it into the transport stream.

The second channel selection control unit 4012 selects the channel of the digital broadcast. That is to say, upon receiving the command to select the channel from the system control unit 4013, the second channel selection control unit 4012 sends a command to select the channel to the second front-end unit 4006. The second front-end unit 4006 can thereby extract and demodulate the electrical wave of the commanded channel and convert it into the transport stream.

The system control unit 4013 controls a channel selection for watching a television in accordance with an operation command from the operation input unit 4014. Moreover, the system control unit 4013 controls the second channel selection control unit 4012 for purpose of accumulating the data broadcast data in the data broadcast accumulation unit 4008. Furthermore, the system control unit 4013 controls a start-up and end of the rendering unit 4009 when watching the television and sends a command to send out the data broadcast data used in the rendering unit 4009 to the data broadcast accumulation unit 4008.

The operation input unit 4014 sends information of operation switches (not illustrated) pressed to operate the digital broadcast receiving apparatus 4000 to the system control unit 4013. The digital broadcast receiving apparatus 4000 may be operated by receiving an operation command from infrared light outputted from an infrared remote controller or receiving an operation command from electrical signals transmitted from other control circuit other than operating the operation switches.

The video output unit 4015 outputs a video to a display panel or the like. The video output unit 4015 is connected to the display panel or the like via an external output terminal such as a component terminal and a HDMI terminal, or a dedicated interface with the display panel.

The sound output unit 4016 outputs sounds to a speaker or the like. The sound output unit 4016 outputs the sound from an analog sound output terminal, an optical digital terminal, a coaxial terminal, or a HDMI terminal and outputs the sound directly to a built-in speaker device via a built-in amplifier circuit or the like.

According to the above configuration, the digital broadcast receiving apparatus 4000 receives the data broadcast of each channel and accumulates the data broadcast in the data broadcast accumulation unit 4008, so that the digital broadcast data which was broadcast on the other channel can be used while watching a certain digital broadcast channel.

Subsequently, an operation of the digital broadcast receiving apparatus 4000 is described.

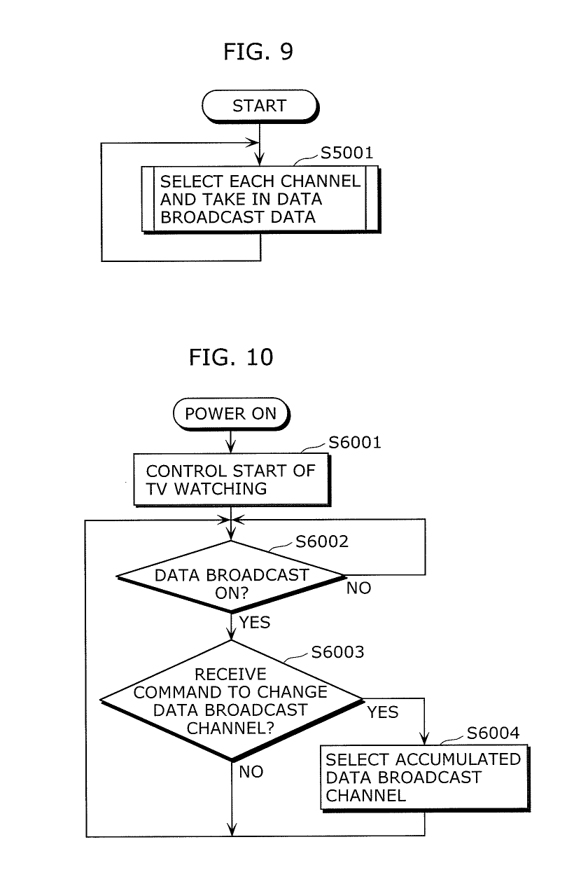

FIG. 9 is a flow chart showing a processing flow of accumulating the data broadcast data in the data broadcast accumulation unit 4008.

Here, there are three digital broadcast channels which can be received, that is, channels A, B, and C.

The digital broadcast receiving apparatus 4000 performs repeatedly the process of accumulating the data broadcast data of each channel (S5001).

FIG. 3 is the flow chart showing the details of the data broadcast data accumulation process (S5001 in FIG. 9).

The system control unit 4013 selects a channel to accumulate the data broadcast data (S7001). Here, the system control unit 4013 selects preferentially the channel whose data broadcast data is not yet accumulated in the data broadcast accumulation unit 4008 and then selects a channel whose data broadcast data is the oldest in the accumulated data broadcast data. Here, the channel A is selected.

Subsequently, the system control unit 4013 sends a command to select the channel A to the second channel selection control unit 4012 and sends a command to start accumulating the data broadcast data of the channel A to the data broadcast accumulation unit 4008. Upon receiving the channel selection command from the second channel selection control unit 4012, the second front-end unit 4006 receives the electrical wave from the antenna 4001, demodulates it, and then outputs the multiplexed transport stream to the second demultiplexing unit 4007 (S7002).

The second demultiplexing unit 4007 analyzes the multiplexed transport stream outputted from the second front-end unit 4006 and sends out the transport stream packet including the data broadcast data to the data broadcast accumulation unit 4008. The data broadcast accumulation unit 4008 accumulates the data broadcast data which corresponds to the channel A (S7003). The data broadcast data accumulation process (S5001) is repeatedly performed. Thus, after the data broadcast data of the channel A is accumulated, the system control unit 4013 also selects the channels B and C and accumulates the data broadcast data of the channels B and C in the same manner and controls the data broadcast accumulation from the channel A again repeatedly.

Subsequently, a process of using the data broadcast data accumulated in the data broadcast accumulation unit 4008 during watching the television is described.

FIG. 10 is a flow chart showing a process flow when using the data broadcast data accumulated in the data broadcast accumulation unit 4008 during watching the television.

Here, the process after turning on the electrical power of the digital broadcast receiving apparatus 4000 is described.

When the electrical power of the digital broadcast receiving apparatus 4000 is turned on, the system control unit 4013 sends a command to select the television broadcast channel, which is to be watched, to the first channel selection control unit 4011.

Upon receiving the channel selection command from the first channel selection control unit 4011, the first front-end unit 4002 receives the electrical wave from the antenna 4001, demodulates it, and then outputs the multiplexed transport stream to the first demultiplexing unit 4003

The first demultiplexing unit 4003 analyzes the multiplexed transport stream outputted from the first front-end unit 4002 and sends out the transport stream packet including the encoded video data and the encoded sound data to the video decoder 4004 and the sound decoder 4005.

The video decoder 4004 decodes the encoded video data which is included in the transport stream packet outputted from the first demultiplexing unit 4003 and outputs the decoded video data.

The sound decoder 4005 decodes the encoded sound data which is included in the transport stream packet outputted from the first demultiplexing unit 4003 and outputs the decoded sound data.

The video composition unit 4010 combines the picture data of the data broadcast data generated by the rendering unit 4009 and the video data generated by the video decoder 4004 and outputs the combined data to the video output unit 4015 (S6001). The data broadcast is not displayed when turning the electrical power on, so that the data outputted from the video composition unit 4010 is the same as the video data generated by the video decoder 4004.

The system control unit 4013 determines whether or not to display the data broadcast in accordance with the command from the operation input unit 4014 or the state in the system control unit 4013 (S6002). When displaying the data broadcast (YES in S6002), the system control unit 4013 sends a command to output the data broadcast data of the channel which the user watches to the data broadcast accumulation unit 4008 and starts up the rendering unit 4009. Moreover, the system control unit 4013 sends a command to select the channel which the user watches to the second channel selection control unit 4012. For example, when the user instructs to display the data broadcast using the operation input unit 4014 while watching the program of channel A as shown in FIG. 5, the program of channel A (the video data) and the data broadcast data of channel A are displayed on the television screen as shown in FIG. 6.

Subsequently, when the system control unit 4013 receives a command to change the data broadcast channel which is currently used from the operation input unit 4014 (YES in S6003), the system control unit 4013 sends a command to change a channel of an outputted data broadcast data to the data broadcast accumulation unit 4008 (S6004). When the data broadcast accumulation unit 4008 accumulates the data broadcast data of the commanded channel, the data broadcast accumulation unit 4008 sends out immediately the data broadcast data to the rendering unit 4009. When the data broadcast accumulation unit 4008 does not accumulate the data broadcast data of the commanded channel, the data broadcast accumulation unit 4008 receives the data broadcast data of the commanded channel from the second demultiplexing unit 4007 and accumulates it. The data broadcast accumulation unit 4008 transmits the valid data broadcast data which is already accumulated in the data broadcast accumulation unit 4008 or the data broadcast data which is being accumulated in the data broadcast accumulation unit 4008 to the rendering unit 4009. Thereby, the data broadcast is updated.

For example, when a command is sent to change the output data of the data broadcast data to the channel B with a television screen displayed as shown in FIG. 6, the program of channel A (the video data) and the data broadcast data of channel B are displayed on the television screen as shown in FIG. 7.

Although Embodiment 2 describes the example of fixing the channel of the program which the user watches and changing the channel of the data broadcast data, it is also applicable to change the channel of the program which the user watches and fix the channel of the data broadcast data.

As described above, according to Embodiment 2, the data broadcast accumulation unit 4008 accumulates the data broadcast data of all channels in advance. Thus, it is possible to change a data broadcast content channel, which is a channel whose data broadcast content is used, without changing a video-sound content channel, which is a channel whose video-sound content is watched and listened to, or change the video-sound content channel without changing the data broadcast content channel.

Although the present invention is described above based on the above Embodiments 1 and 2, the present invention is not limited to those in Embodiments 1 and 2.

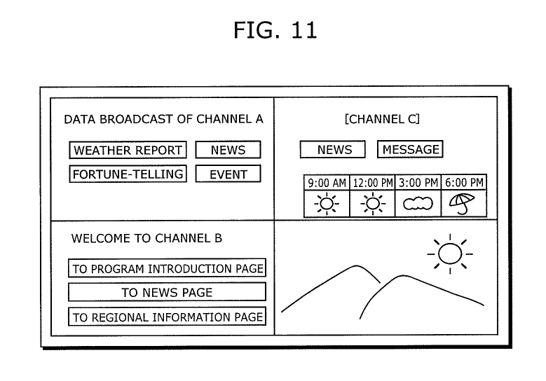

For example, not only switching the data broadcast channel during watching the television can be achieved, but accessibility to the data broadcast can also be enhanced by displaying the data broadcast data of each channel accumulated in the data broadcast accumulation unit side-by-side on one screen. FIG. 11 illustrates an example of displaying the data broadcast data of the three channels, the channels A to C, side-by-side on one screen.

Moreover, it is also applicable that when accumulating the data broadcast data in the data broadcast accumulation unit, the data broadcast data of the channel which is instructed by the user in advance is preferentially accumulated instead of accumulating preferentially the data broadcast data of the channel corresponding to the data broadcast data which is the oldest in the updated data broadcast data.

Moreover, in Embodiment 2, it is also applicable that the data broadcast accumulation unit 4008 has a region to accumulate the data broadcast data of one channel, sends a command to select the channel to the second channel selection control unit 4012 every time when the channel of the data broadcast is switched, and sends out the data broadcast data which is accumulated at that time to the rendering unit 4009 each time. According to such a configuration, although it requires some time to display the data broadcast data, a capacity of the data broadcast accumulation unit 4008 can be made smaller.

Moreover, in Embodiment 2, it is described that the first front-end unit 4002 and the first demultiplexing unit 4003 are used for watching and listening to the video and the sound, and the second front-end unit 4006 and the second demultiplexing unit 4007 are used for receiving the data broadcast, however, the present invention is not limited to this configuration. For example, a crossbar switch configuration is applied to a connection of the first demultiplexing unit 4003 and the second demultiplexing unit 4007 with the video decoder 4004 and the sound decoder 4005 and with the data broadcast accumulation unit 4008. According to such a configuration, the second front-end unit 4006 and the second demultiplexing unit 4007 can be used for watching and listening to the video and the sound, and the first front-end unit 4002 and the first demultiplexing unit 4003 can be used for receiving the data broadcast.

Moreover, in Embodiment 2, the input system of the data broadcast transport stream packet from the demultiplexing unit to the data broadcast accumulation unit 4008 may be increased in number. That is to say, the first demultiplexing unit 4003 and the second demultiplexing unit 4007 may be connected to the data broadcast accumulation unit 4008, respectively. According to such a configuration, the plural systems of the front-end units and the demultiplexing units in the digital broadcast receiving apparatus are not used, the plural front-end units and the plural demultiplexing units are operated in parallel to receive the data broadcast, so that the time to take all the data broadcast data which are broadcast can be reduced.

Moreover, the system of the demultiplexing unit may be increased in number in a digital broadcast receiving apparatus corresponding to both a satellite wave digital broadcast and a terrestrial digital broadcast, for example. That is to say, the first demultiplexing unit 4003 and the second demultiplexing unit 4007 may be connected to the video decoder 4004, the sound decoder 4005, and the data broadcast accumulation unit 4008, respectively. According to such a configuration, data broadcast of the satellite wave digital broadcast may be accumulated in the data broadcast accumulation unit 4008 during receiving the terrestrial digital broadcast or data broadcast of the terrestrial digital broadcast may be accumulated in the data broadcast accumulation unit 4008 during receiving the satellite wave digital broadcast.

Moreover, each apparatus described above may be constructed as a computer system which is made up of, in particular, a microprocessor, a ROM, a RAM, a hard disk drive, a display unit, a keyboard, a mouse, etc. A computer program is stored in the RAM or the hard disk drive. Each apparatus achieves its function when the microprocessor operates in accordance with the computer program. Here, the computer program is made up of a combination of plural operation codes indicating a command to a computer to achieve a predetermined function.

Furthermore, a part or all of the constituent elements of each apparatus described above may be made up of one system LSI (Large Scale Integration). The system LSI is a super multifunctional LSI manufactured by integrating plural structural units on one chip, and in particular, it is a computer system including a microprocessor, a ROM, a RAM, etc. A computer program is stored in the RAM. The system LSI achieves its function as the microprocessor operates in accordance with the computer program.

Furthermore, a part or all of the constituent elements of each apparatus described above may be made up of an IC card which can be attached to and detached from each apparatus or a stand-alone module. The IC card or the module is a computer system which is made up of a microprocessor, a ROM, a RAM, etc. The IC card or the module may include the above super multifunctional LSI. The IC card or the module achieves its function as the microprocessor operates in accordance with the computer program. The IC card or the module may be tamper-resistant.

Moreover, the present invention may be the methods described above. Moreover, the present invention may be a computer program which achieves the methods by a computer and may be digital signals made up of the computer program.

Furthermore, the present invention may be a computer-readable recording medium such as a flexible disk, a hard disk, a CD-ROM, an MO, a DVD, a DVD-ROM, a DVD-RAM, a BD (Blu-ray Disc (registered trademark)), a semiconductor memory, or the like in which the computer program or the digital signals are recorded. Moreover, the present invention may be the above digital signals which are recorded in these recording media.

Moreover, the present invention may transmit the above computer program or digital signals via an electrical communication circuit, a wireless or wired communication circuit, a network such as Internet, a data broadcast, etc.

Moreover, the present invention may be a computer system provided with a microprocessor and a memory in which the memory may store the above computer program and the microprocessor may operate in accordance with the above computer program.

Moreover, the present invention may be carried out by another independent computer system by transferring the above program or the digital signals recorded in the recording medium or transferring the program or the digital signals via the above network or the like.

Furthermore, the present invention may be any combination of the above embodiments and modifications.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention may be applied to a digital broadcast receiving apparatus for receiving a terrestrial digital broadcast and a satellite wave digital broadcast. In particular, the present invention may be applied to a digital broadcast receiving apparatus such as a household television, a video recorder, a set-top box, an in-car television, a portable television, a car navigation system, a personal computer, a handheld terminal, a mobile phone equipment, etc.

What is claimed is:

1. A digital broadcast receiving apparatus that receives electrical wave of a digital broadcast and outputs video data of the digital broadcast, said digital broadcast receiving apparatus comprising:
a channel selection control unit configured to select a channel of the digital broadcast;
an acquisition unit configured to obtain video data and data broadcast data from electrical wave of the digital broadcast of the channel selected by said channel selection control unit;
a data broadcast accumulation unit having a storage region for each channel and configured to accumulate the data broadcast data obtained by said acquisition unit in the storage region of the channel selected by said channel selection control unit; and
a composition unit configured to generate composite video data by reading out the data broadcast data of at least one channel that includes a channel different from a channel of the video data obtained by said acquisition unit from said data broadcast accumulation unit and combining the readout data broadcast data and the video data obtained by said acquisition unit.

2. The digital broadcast receiving apparatus according to claim 1,
wherein said acquisition unit includes:
a front-end unit configured to demodulate the electrical wave of the digital broadcast of the channel selected by said channel selection control unit into digital signals;
a demultiplexing unit configured to demultiplex encoded video data and data broadcast data from the digital signals; and
a video decoder which decodes the encoded video data,
said data broadcast accumulation unit has a storage region for each channel and is configured to accumulate the data broadcast data demultiplexed by said demultiplexing unit in the storage region of the channel selected by said channel selection control unit, and
said composition unit includes:
a rendering unit configured to generate picture data of data broadcast data of at least one channel which includes a channel different from the channel of the electrical wave of the digital broadcast demodulated by said front-end unit in accordance with the data broadcast data accumulated in said data broadcast accumulation unit; and
a video composition unit configured to generate composite video data by combining the video data decoded by said video decoder and the picture data generated by said rendering unit.

3. The digital broadcast receiving apparatus according to claim 2, further comprising:
a CM (Commercial Message) detection unit configured to detect a CM of the digital broadcast of the channel specified by said channel selection control unit; and
a system control unit configured to control said channel selection control unit to select a channel which is different from a channel corresponding to the electrical wave which is currently demodulated by said front-end unit during a period of time when said CM detection unit detects a CM.

4. The digital broadcast receiving apparatus according to claim 3,
wherein said CM detection unit is configured to detect a CM in accordance with a change of supplementary information included in the encoded video data.

5. The digital broadcast receiving apparatus according to claim 3,
wherein said CM detection unit is configured to detect a CM in accordance with a state that a timing of a switch between a CM and a program (or vice versa) indicates a moment at which the supplementary information included in the encoded video data changes.

6. The digital broadcast receiving apparatus according to claim 3,
wherein said demultiplexing unit is configured to demultiplex encoded video data, encoded sound data, and data broadcast data from the digital signals,
said digital broadcast receiving apparatus further comprises a sound decoder configured to decode the encoded sound data, and
said CM detection unit is configured to detect a CM in accordance with a change of supplementary information included in the encoded sound data.

7. The digital broadcast receiving apparatus according to claim 3,
wherein said demultiplexing unit is configured to demultiplex encoded video data, encoded sound data, and data broadcast data from the digital signals,
said digital broadcast receiving apparatus further comprises a sound decoder configured to decode the encoded sound data, and
said CM detection unit detects a CM in accordance with a state that a timing of a switch between a CM and a program (or vice versa) indicates a moment at which the supplementary information included in the encoded video data changes.

8. The digital broadcast receiving apparatus according to claim 2, further comprising:
a state management unit configured to manage a period of time when said front-end unit or said demultiplexing unit can be operated for purpose of accumulating the data broadcast data in said data broadcast accumulation unit; and
a system control unit configured to control said selection channel control unit to select at least one channel in a period of time when said front-end unit or said demultiplexing unit can be operated for purpose of accumulating the data broadcast data in said data broadcast accumulation unit.

9. The digital broadcast receiving apparatus according to claim 8,
wherein said state management unit is configured to manage a period of time when electrical power of said digital broadcast receiving apparatus is turned on as a period of time when said front-end unit or said demultiplexing unit can be operated except for a purpose of accumulating the data broadcast data in said data broadcast accumulation unit, and
said state management unit is configured to manage a period of time when electrical power of said digital broadcast receiving apparatus is turned off as a period of time when said front-end unit or said demultiplexing unit can be operated for purpose of accumulating the data broadcast data in said data broadcast accumulation unit.

10. A digital broadcast receiving apparatus that receives electrical wave of a digital broadcast and outputs video data of the digital broadcast, said digital broadcast receiving apparatus comprising:
a first channel selection control unit configured to select a first channel of the digital broadcast;
a second channel selection control unit configured to select a second channel of the digital broadcast;
a first front-end unit configured to demodulate the electrical wave of the digital broadcast of the channel selected by said first channel selection control unit into first digital signals;
a second front-end unit configured to demodulate the electrical wave of the digital broadcast of the channel selected by said second channel selection control unit into second digital signals;
a first demultiplexing unit configured to demultiplex encoded video data and data broadcast data from the first digital signals;
a second demultiplexing unit configured to demultiplex encoded video data and data broadcast data from the second digital signals;
a video decoder which decodes the encoded video data demultiplexed by said first demultiplexing unit;
a data broadcast accumulation unit having a storage region for each channel and configured to accumulate the data broadcast data demultiplexed by said second demultiplexing unit in the storage region of the channel selected by said second channel selection control unit;
a rendering unit configured to generate picture data of data broadcast data of at least one channel which includes a channel different from the channel of the electrical wave of the digital broadcast demodulated by said first front-end unit in accordance with the data broadcast data accumulated in said data broadcast accumulation unit; and
a video composition unit configured to generate synthesized video data by combining the video data decoded by said video decoder and the picture data generated by said rendering unit.

11. A digital broadcast receiving apparatus that receives electrical wave of a digital broadcast and outputs video data of the digital broadcast, said digital broadcast receiving apparatus comprising:
a first channel selection control unit configured to select a first channel of the digital broadcast;
a second channel selection control unit configured to select a second channel of the digital broadcast;
a first front-end unit configured to demodulate the electrical wave of the digital broadcast of the channel selected by said first channel selection control unit into first digital signals;
a second front-end unit configured to demodulate the electrical wave of the digital broadcast of the channel selected by said second channel selection control unit into second digital signals;
a first demultiplexing unit configured to demultiplex encoded video data and data broadcast data from the first digital signals;
a second demultiplexing unit configured to demultiplex encoded video data and data broadcast data from the second digital signals;
a video decoder which decodes the encoded video data demultiplexed by said first demultiplexing unit or said second demultiplexing unit;
a data broadcast accumulation unit having a storage region for each channel and configured to accumulate the data broadcast data demultiplexed by said first demultiplexing unit in the storage region of the channel selected by said first channel selection control unit and accumulate the data broadcast data demultiplexed by said second demultiplexing unit in the storage region of the channel selected by said second channel selection control unit;
a rendering unit configured to generate picture data of data broadcast data of at least one channel which includes a channel different from the channel of the electrical wave of the digital broadcast demodulated by said first front-end unit or said second front-end unit in accordance with the data broadcast data accumulated in said data broadcast accumulation unit; and
a video composition unit configured to generate composite video data by combining the video data decoded by the video decoder and the picture data generated by said rendering unit.

12. The digital broadcast receiving apparatus according to claim 2,
wherein said rendering unit generates picture data of data broadcast data of plural channels in accordance with the data broadcast data accumulated in said data broadcast accumulation unit.

13. A digital broadcast receiving method of receiving electrical wave of a digital broadcast and outputting video data of the digital broadcast, comprising:
selecting a channel of the digital broadcast;
obtaining video data and data broadcast data from electrical wave of the digital broadcast of the channel selected in said selecting;
accumulating, for each channel, the data broadcast data obtained in said obtaining in a data broadcast accumulation unit; and
generating composite video data by reading out the data broadcast data of at least one channel that includes a channel different from a channel of the video data obtained in said obtaining from said data broadcast accumulation unit and combining the readout data broadcast data and the video data obtained in said obtaining.
